(19) United States
(12) Patent Application Publication
(10) Pub. No.: US 2013/0335439 A1
(43) Pub. Date: Dec. 19, 2013

(54) SYSTEM AND METHOD FOR CONVERTING COLOR GAMUT

(71) Applicant: SAMSUNG DISPLAY CO., LTD., Yongin-City (KR)

(72) Inventors: Geun-Young Jeong, Yongin-City (KR); Won-Woo Jang, Yongin-City (KR); Jong-Woong Park, Yongin-City (KR); Ji-Yeon Yang, Yongin-City (KR); Joo-Hyung Lee, Yongin-City (KR)

(73) Assignee: Samsung Display Co., Ltd., Yongin-City (KR)

(21) Appl. No.: 13/677,230

(22) Filed: Nov. 14, 2012

(30) Foreign Application Priority Data
Jun. 18, 2012 (KR) 10-2012-0065041

(51) Int. Cl. G09G 5/02

(52) U.S. Cl. CPC G09G 5/02
USPC 345/590

(57) ABSTRACT

A color gamut conversion system comprising a color gamut conversion function generator, a color gamut converter, and a scaler is disclosed. In some embodiments, the color gamut conversion function generator is configured to generate a color gamut conversion function for determining an intermediate color gamut located in a color space between a predetermined color gamut corresponding to a display panel of a display device and a standard color gamut, the color gamut converter is configured to receive input data supplied from an external image source and convert a color coordinate of the input data according to the generated color gamut conversion function and the scaler configured is to scale a value of the data converted by the color gamut converter, generate the value as output data, and transfer the output data.

### CROSS-REFERENCE TO RELATED APPLICATION

This application claims priority to and the benefit of Korean Patent Application No. 10-2012-0065041 filed in the Korean Intellectual Property Office on Jun. 18, 2012, the entire contents of which are incorporated herein by reference.

### BACKGROUND OF THE INVENTION

1. Field

The present disclosure relates to a system and a method for converting a color gamut, and more particularly, to a system and a method for converting a color gamut capable of implementing an optimum image quality by maintaining color accuracy in a display device having a wide color gamut, such as in an organic light emitting diode (OLED) display, which is capable of exhibiting a high color expression ability at the same time.

2. Description of the Related Technology

In general, apparatuses for reproducing colors such as a monitor, a display panel, a scanner, a printer and the like use different color spaces or color models according to each field employing the apparatuses. For example, a printing apparatus of a color image uses a CMY color space, a color CRT monitor or a computer graphic apparatus uses an RGB color space, and apparatuses which handle color, chroma, and luminance use an HSI color space.

Further, a CIE color space corresponding to a luminance and chrominance signal based color space is used to define an apparatus-dependent color which can be accurately reproduced in any apparatus, and includes CIE-LAB color spaces, CIE-xyY color spaces, CIE-CAM02 color spaces, and the like.

In general, a color gamut adjustment is implemented after inputting a standard broad color gamut signal which is mapped into a limited color reproduction range (hereinafter, referred to as a color gamut) of the display. The color gamut adjustment is implemented through detailed adjustments for a color area by detecting a standard color (sRGB, Rec709) and a display color gamut boundary after a conversion to a CIE-xyY space is performed. A display color gamut for the input standard signal is mapped, and the color gamut is mapped based on the detected color area and the display color gamut boundary.

In some embodiments, broad color gamut linear RGB signals are converted to CIE-XYZ tristimulus values, and a color coordinate signal implements a local hue adjustment for RGB primary colors in a CIE-xy color coordinate system and CMY hue after calculating CIE-xy and Y corresponding to a brightness signal based on the conversion. Further, a color gamut mapping technology is implemented by calculating a standard color signal and display target color gamut information and performing compensation for chroma and brightness according to the information.

A display device such as the OLED display, which has a wide color gamut, can display, for example, contents containing many more colors, such as darker reds, in comparison with a conventional display device.

However, since a current image color standard and a color gamut of a video to which such a color standard is applied are small, when the video content is reproduced in a display device having a wide color gamut, the color may look emphasized or exaggerated.

Accordingly, a display color gamut may simply be converted to a reduced standard color gamut such as sRGB in order to suppress such color deformation. The sRGB color camut provides the advantage of expressing a more accurate color, but is unable to abundantly express a high color depth or range.

Accordingly, a technology which can strengthen an advantage of abundantly expressing the high color of a display device having a wide color gamut and converting a color gamut of the display device so that the color accuracy is increased.

The above information disclosed in the Background section is only for enhancement of understanding of the background of the invention and therefore it may contain information that does not form the prior art that is already known in this country to a person of ordinary skill in the art.

### SUMMARY OF CERTAIN INVENTIVE ASPECTS

The present disclosure provides a system and a method for converting a color gamut capable of achieving an optimum image quality of a display device by using the high color expression ability of a display device which has a wide color gamut and also allowing for accurate color implementation.

Embodiments as described herein adaptively adjust a color area according to an input image and a characteristic for each pixel of a display panel, implement a high image quality by suppressing a visibly exaggerated color, and improve visibility by adjusting the visibility according to an environmental factor such as external illuminance.

Further, embodiments as described herein allow a self-light emitting display, the power consumption of which is sensitive to a change in a pixel data value. The self-emitting displays described herein also perform a color gamut adjustment as well as provide for power consumption control.

Some embodiments disclosed herein describe a system for converting a color gamut, including: a color gamut conversion function generator for generating a color gamut conversion function for determining an intermediate color gamut which is located in a color space between a predetermined color gamut corresponding to a display panel of a display device and a standard color gamut; a color gamut converter for receiving input data supplied from an external image source and converting a color coordinate of the input data according to the generated color gamut conversion function; and a scaler for scaling a value of the data converted by the color gamut converter, generating the value as output data, and transferring the output data.

The color gamut conversion system may further include a frame buffer connected to a front end or a back end of the color gamut converter. The frame buffer connected to the front end of the color gamut converter may store the input data and the frame buffer connected to the back end of the color gamut converter may store input data converted according to the generated color gamut conversion function.

The color gamut conversion system may further include an external illuminance controller for obtaining external illuminance information of the display device and transferring the illuminance information to the scaler in order to control a supply of consumed power of the display device, the external illuminance controller being mounted to the back end of the frame buffer.

The color gamut conversion system may further include an image analyzer for receiving the input data to generate a result value analyzed from characteristic information included in the input data and transferring the result value to the color gamut conversion function generator as one factor for generating the color gamut conversion function.

The result value may be at least one of an image characteristic of the input data, a color saturation degree characteristic for each pixel, and classification information for each type of a color saturation degree distribution for each image.

The result value may be an image characteristic of the input data or a color saturation degree characteristic for each pixel, and the color gamut conversion function generator may determine the color gamut conversion function for calculating the intermediate color gamut between a predetermined original color gamut and a standard color gamut which is aimed, by using a weight factor based on the result value.

The weight factor may have a predetermined value according to the color saturation degree and a variable value in a predetermined high color area.

When the weight factor variable, the color gamut conversion function for calculating the intermediate color gamut may be non-linearly changed closely to the predetermined original color gamut in the predetermined high color area.

The multiple weight factors may be determined by parameters including a minimum value, a maximum value, a middle value between the minimum value and the maximum value, and an input color saturation turning point corresponding to a color saturation degree at a point where a tendency of the weight factor is changed.

The result value may be information generated by analyzing the input data and classifying a color saturation degree distribution for each image, for each type according to color saturation degree areas of at least three stages, and the color gamut conversion function generator may match the color gamut conversion function for calculating the intermediate color gamut based on the result value for each type to determine the color gamut conversion function.

The color gamut conversion system may further comprise a mode selector configured to include at least one user-selectable color setting mode for controlling a screen color of the display panel and to transfer the user-selected color setting mode information to the color gamut conversion function generator.

The color setting mode may be selected from one of a plurality of modes: off mode in which a color control is not performed, an accurate mode in which color accuracy and image definition are improved, a moderate mode in which a basically set color control is performed, an aggressive mode in which a high color gamut of the display panel is used, and an adaptive mode in which a color control is automatically performed according to an image characteristic of an input image, but not limited thereto.

The mode selector may transfer a weight factor corresponding to the one mode information among one or more weight factors preset corresponding to the respective one or more color setting modes to the color gamut conversion function generator.

The color gamut conversion system may further include an external illuminance controller for obtaining external environment information of the display device, and transferring the external environment information to the color gamut conversion function generator as one factor for generating the color gamut conversion function for determining the intermediate color gamut.

Another embodiment as described herein provides a method of converting a color gamut, including: receiving one or more factors for determining an intermediate color gamut located in a color space between a predetermined color gamut corresponding to a display panel of a display device and a standard color gamut and generating a color gamut conversion function; receiving input data from an external image source and converting a color coordinate of the input data according to the generated color gamut conversion function; and scaling a value of the converted data and output the value as output data.

The color gamut conversion method may further include storing the input data in a frame buffer before or after the converting of the color coordinate of the input data according to the generated color gamut conversion function.

During scaling the value of the converted data, external illuminance information of the display device may be obtained and the illuminance information is transferred to control a supply of consumed power of the display device.

The color gamut conversion method may further include obtaining one or more factors before the generating of the color gamut conversion function. The one or more factors may be at least one of a first weight factor according to image characteristic information of the input data or color saturation degree characteristic information for each pixel, one or more second weight factors preset according to one or more color setting modes for controlling a screen color of the display panel, external environment information of the display device, and classification information for each type of a color saturation degree distribution for each image analyzed from the input data.

It is possible to provide a system and a method for converting a color gamut which simultaneously exhibit color accuracy and high color expression in a display device having a wide color gamut.

Specifically, it is possible to provide a function of adjusting a color gamut conversion intensity according to the weight factor to an algorithm of fixedly converting a predetermined color gamut to a target color gamut and a function of automatically selecting and applying a color conversion function (weight factor curve) according to a color saturation degree distribution characteristic of an image. Accordingly, it is possible to provide a display device which can basically maintain color accuracy close to the target color gamut in a low color area and exhibit an inherent high color expression ability of the display device in a high color area.

Further, by differently applying a color conversion function through color distribution analysis for each image characteristic in order to remove side effects which may be generated in the color conversion such as color exaggeration, boundary part recognition and the like, an optimum image quality can be achieved.

In addition, outdoor visibility can be improved by adjusting the color gamut conversion intensity or the curve according to external illuminance, and power consumption of the display device can be reduced by adjusting the scale of a final data value according to the illuminance.

Moreover, it is possible to reduce power consumption of the self-light emitting display by adjusting the final data value such that a data change generated due to the color gamut conversion does not become a factor contributing to an increase in power consumption by considering the characteristics of the self-light emitting display having the power consumption sensitive to the data value.

### BRIEF DESCRIPTION OF THE DRAWINGS

FIG. 1 is a block diagram illustrating a configuration of a color gamut conversion system according to an exemplary embodiment.

FIG. 2 is illustrates a graph showing a color gamut conversion method in the related art.

FIG. 3 is a diagram illustrating a process of calculating a color extreme value of a target color gamut in a color gamut conversion method according to an exemplary embodiment.

FIG. 4 is a diagram illustrating a color gamut modified in an RGB color space in accordance with a color gamut conversion method according to an exemplary embodiment.

FIG. 5 is a diagram illustrating generation of an intermediate color gamut between an original color gamut and a target color gamut in accordance with a color gamut conversion method according to an exemplary embodiment.

FIGS. 6 and 7 illustrate graphs showing an example of forming an intermediate color gamut coordinate in accordance with a color gamut conversion method according to an exemplary embodiment.

FIGS. 8 and 9 illustrate graphs showing a relation between a saturation degree of a color and a color gamut conversion weight factor.

FIGS. 10 to 12 illustrate graphs showing an intermediate color gamut conversion curve generated when a simple weight factor is applied to a color gamut conversion method according to an exemplary embodiment.

FIGS. 13 to 16 illustrate graphs showing an intermediate color gamut conversion curve generated when various weight factors are applied to a color gamut conversion method according to an exemplary embodiment.

FIGS. 17 and 18 are diagrams illustratively showing a distribution of a color saturation degree for each image of an input image.

FIG. 19 is a diagram illustrating an example of a color gamut conversion curve generated according to a classification of characteristics for each image in a color gamut conversion method according to an exemplary embodiment.

FIGS. 20 to 23 are diagrams illustrating an example of a color gamut conversion curve variously generated according to distribution characteristics of a color saturation degree of for each of various images in a color gamut conversion method according to an exemplary embodiment.

FIGS. 24 and 25 are block diagrams illustrating a configuration of a color gamut conversion system according to an exemplary embodiment.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element.

Further, unless explicitly described to the contrary, the word, “comprise” and variations such as “comprises” or “comprising” will be understood to mean the inclusion of stated elements but not the exclusion of any other elements.

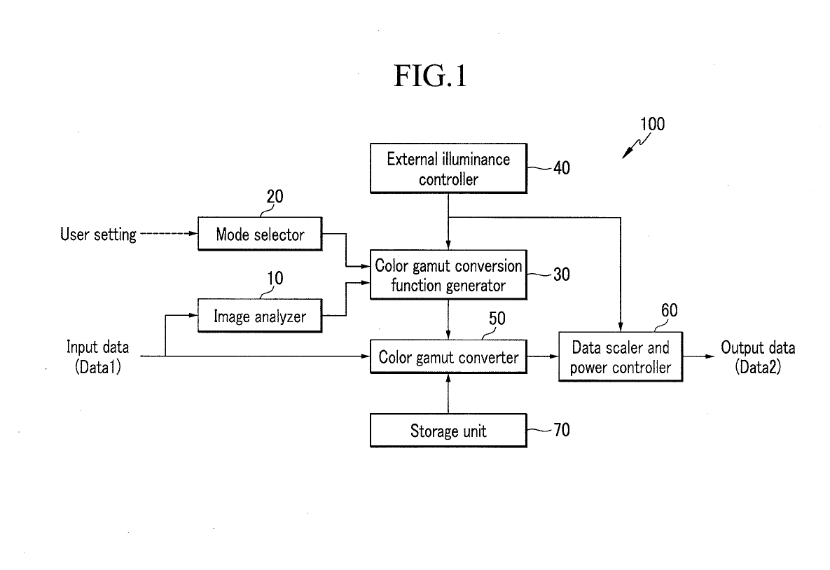

FIG. 1 is a block diagram illustrating a configuration of a color gamut conversion system 100 according to an exemplary embodiment of the present invention.

The color gamut conversion system 100 of FIG. 1 includes an image analyzer 10, a mode selector 20, a color gamut conversion function generator 30, an external illuminance controller 40, a color gamut converter 50, a data scaler and power controller 60 and storage unit 70.

Input data Data1 from an external image source is transferred to the image analyzer 10 and the color gamut converter 50.

Data1 transferred to the color gamut converter 50 is re-mapped to a new color coordinator through the data scaler and power controller 60 according to a color gamut conversion function generated by a color gamut conversion method as described herein. The re-mapped Data1 is then supplied to a data driver of a display device as output data Data2.

Meanwhile, Data1 transferred to the image analyzer 10 is used for analyzing information on color distribution and color saturation for each pixel of an image for generating a proper color gamut conversion function according to the color gamut conversion method described herein.

For better understanding and ease of description, the color gamut converter 50 among the configuration of the color gamut conversion system of FIG. 1 according to an exemplary embodiment of the present invention will be described first.

The color gamut converter 50 generates an intermediate color gamut between an original color gamut and a standard color gamut (target color gamut) of general video content and converts a chromaticity coordinate (color coordinate) according to the generated intermediate color gamut in order to simultaneously implement a high color expression ability and accurate color reproduction. The color gamut conversion function is generated according to the characteristics of the image, or according to a user-set weight factor mode. The generated color gamut conversion function is used to determine the intermediate color gamut, which will be described below.

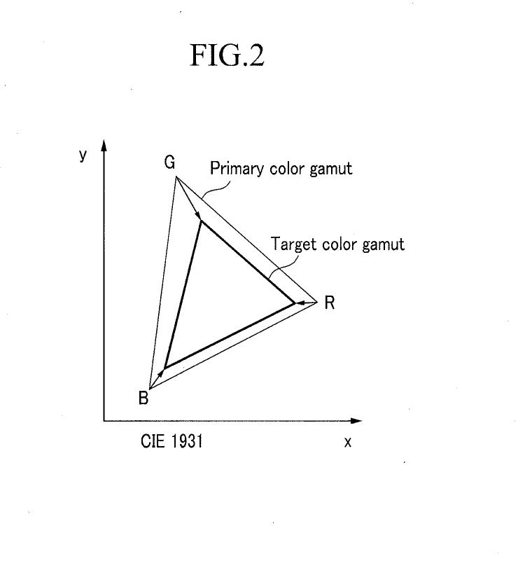

FIG. 2 illustrates a graph showing the color gamut conversion method. The color gamut conversion method reduces the original color gamut of the display panel to the standard color gamut of general video content, to a color gamut which is aimed, e.g., sRGB, Adobe RGB, and the like, hereinafter, referred to as a “target color gamut) as shown in FIG. 2. A display device having a narrow color gamut may exhibit similar display properties as that of the display device having the wide color gamut by increasing an intensity of an intermediate color area.

In most cases, the target color gamut is fixed by a user's selection or an initial setting. The target color gamut is fixed to a particular color gamut such as standard RGB (sRGB), and an image based on the sRGB can be output to the display device with high color accuracy.

However, the fixed color gamut conversion method as shown in FIG. 2 can increase the color accuracy based on the particular color gamut such as sRGB, but cannot strengthen an advantage of a high color display device capable of expressing abundant colors like the organic light emitting diode (OLED) display since a color gamut of the high color display device is not used.

Further, the fixed color gamut conversion method is limited in implementing an image quality because only the target color gamut is set, and thus it is not possible to perform an adaptive color gamut conversion according a user interface, characteristics of an input image, or the environment in which the display is used. That is, the color gamut conversion by the fixed target color gamut corresponds to a scheme in which the intensity is difficult to adjust gradually or stage by stage. Thus, outdoor visibility may suffer. Additionally, it is difficult to compensate for or control an increase in power consumption of a self-light emitting display due to a data modulation.

Accordingly, the color gamut conversion method and system described herein determine an intermediate color gamut in which the color gamut conversion can be elastically performed, converting between the original color gamut and the target color gamut, using factors such as user settings, characteristics of the input image, the environment and the like.

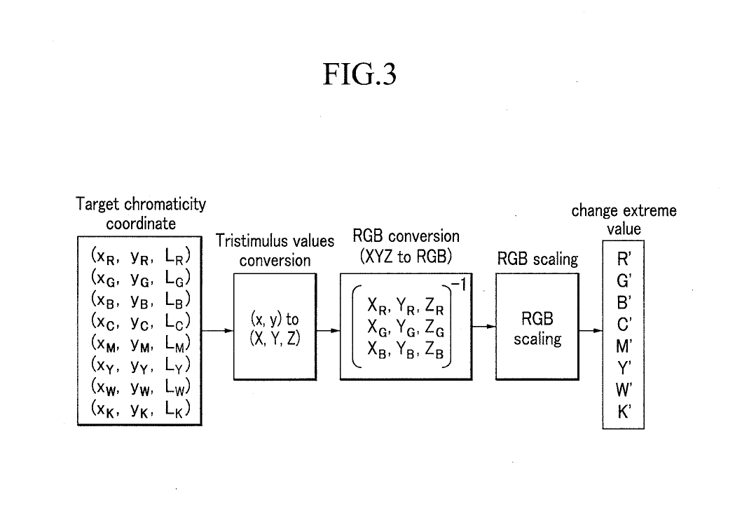

FIG. 3 is a partial process of a color gamut conversion method according to an exemplary embodiment of the present invention, and is a diagram illustrating a process of calculating an extreme value of a color of a target color gamut. The process is the same as the process of calculating the extreme value of the color of the target color gamut in the color gamut conversion method in the related art. That is, the process refers to a process of newly calculating the extreme value of the color which is a reference for the conversion into the color coordinate of the target color gamut.

A basic color gamut conversion is achieved in the RGB color space, and a determined color space (hexahedron) includes eight vertices, that is, R (red), G (green), B (blue), C (cyan), M (magenta), Y (yellow), W (white), and Black (black). When eight new extreme points newly calculated and applied to convert the color gamut, the rectangular hexahedron is reduced and altered. Values actually used in the changed RGB color space are calculated through three-dimensional linear interpolation.

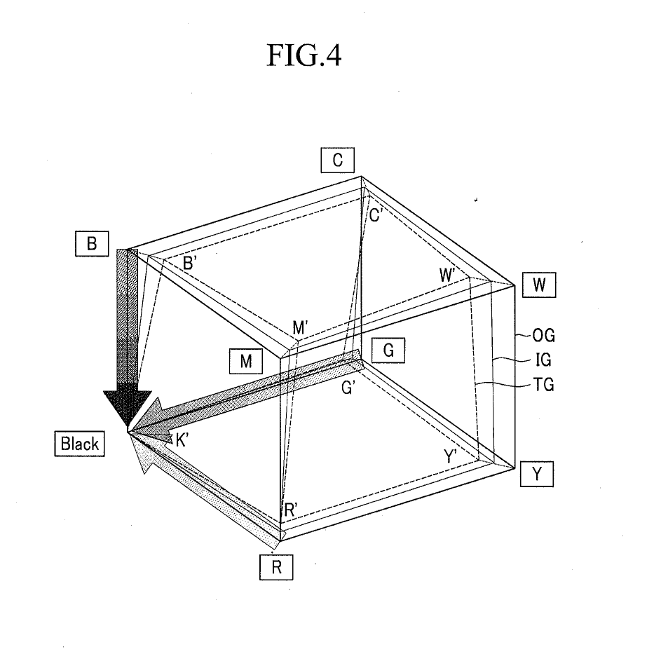

FIG. 3 illustrates a method of calculating eight different RGB extreme values. When a target color coordinate (chromaticity coordinate) based on a CIE 1931 coordinate system is input, a conversion to tristimulus values X, Y, and Z is performed. Further, new eight extreme values R′, G′, B′, C′, M′, Y′, W′ and K′ of the RGB color space are calculated through an RGB conversion (XYZ to RGB) and an RGB scaling, including color characteristics of the display device. The extreme values are illustrated in the RGB color space as shown in FIG. 4.

FIG. 4 illustrates together an original color gamut OG, a target color gamut TG and an intermediate color gamut IG determined according to a color gamut conversion method according to an exemplary embodiment of the present invention in the RGB color space.

As partially indicated by three arrows on the original color gamut OG in FIG. 4, brightness of a color is gradually reduced as an extreme point of the corresponding color such as red R, green G and blue B moves in a direction of black, and thus the color becomes dark such as black. In contrast, although not illustrated in FIG. 4, when the color moves in a direction of white, luminance of the color corresponding to each extreme point is gradually increased, and thus the color becomes bright white.

The target color gamut TG and the intermediate color gamut IG in the RGB color space have only a different color gamut from the original color gamut OG, and have the same arrangement of each color since the color is gradually arranged between respective extreme points.

Referring to FIG. 4, the new color extreme values R′, G′, B′, C′, M′, Y′, W′ and K′ calculated through the method of FIG. 3 are located further within the RGB color space of the rectangular hexahedron by a predetermined distance in comparison with positions of the extreme values R, G, B, C, M, Y, W and Black of the original color gamut.

The color gamut conversion system and method do not perform the conversion to the fixed target color gamut using the extreme value of the target gamut like the method of FIG. 3, but process such that the determined intermediate color gamut IG is between the target color gamut TG and the original color gamut OG measured according to a weight factor of 0 to 100% by the color gamut converter 50 of the color gamut conversion system 100 of FIG. 1.

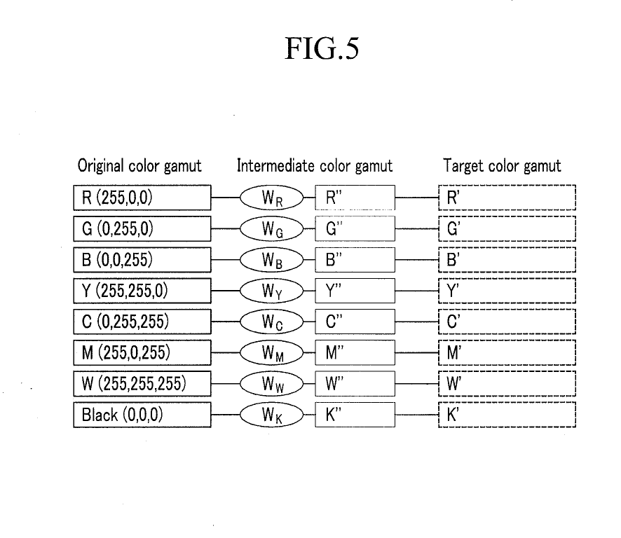

FIG. 5 illustrates that the intermediate color gamut IG between the original color gamut OG and the target color gamut TG is linearly generated according to a weight factor most basically in accordance with a color gamut conversion method according to an exemplary embodiment.

FIG. 5 illustrates a color extreme value of each color gamut as an example. Each of eight intermediate color gamut extreme values R″, G″, B″, C″, M″, Y″, W″ and K″ are determined to be between each of the eight original color gamut extreme values R, G, B, C, M, Y, W and Black and each of the eight target color gamut extreme values R′, G′, B′, C′, M′, Y′, W′ and K′.to which weight factors W_{R}, W_{G}, W_{B}, W_{C}, W_{M}, W_{Y}, W_{W} and W_{K} corresponding to respective color coordinates are applied.

One value may be equally applied to the weight factors (case.g., W_{R}=W_{G}=W_{B}=W_{C}=W_{M}=W_{Y}=W_{w}=W_{K}), or different values may be applied to each weight factors according to the color extreme value (in this case, W_{R}≠W_{G}≠W_{B}≠W_{C}≠W_{M}≠W_{Y}≠W_{W}≠W_{K}).

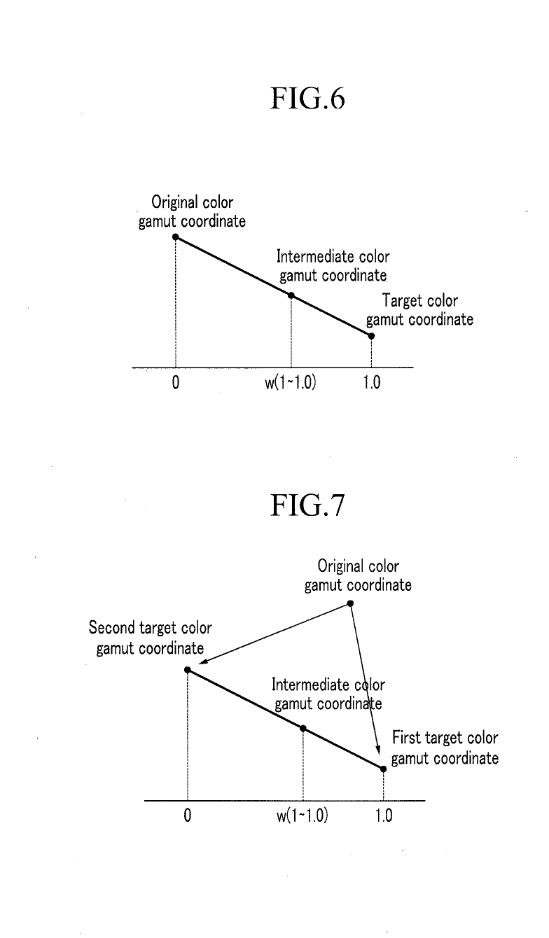

FIGS. 6 and 7 illustrate graphs showing methods of generating an intermediate color gamut coordinate as different exemplary embodiments. That is, FIGS. 6 and 7 are diagrams specifically illustrating methods of determining the color coordinate of the intermediate color gamut between the color coordinate of the original color gamut and the color coordinate of the target color gamut when the intermediate color gamut is generated by applying the weight factors in FIG. 5. FIGS. 6 and 7 simplify the color space, which is actually three-dimensional space, to a two-dimensional space for ease of the description.

Referring to FIG. 6, the intermediate color gamut coordinate in the RGB space is determined by a linear expression. That is, the intermediate color gamut coordinate is determined on a straight line connecting between the original color gamut coordinate and the target color gamut coordinate according to weight factor W.

The original color gamut coordinate refers to a color coordinate transferred to each pixel of the panel based on the original color gamut corresponding to an inherent panel color gamut determined according to a function or a characteristic of the display device. Further, the target color gamut coordinate refers to a color coordinate converted from the original color gamut coordinate such that each target color gamut coordinate corresponds to each original color gamut coordinate according to a target color gamut reference generally determined in accordance with a general video signal by a user's setting or an initial setting.

The intermediate color gamut coordinate may be determined between the original color gamut coordinate and the target color gamut coordinate by applying the weight factor.

As another exemplary embodiment of determining the intermediate color gamut coordinate, two or more target color gamuts are set based on the original color gamut, and the intermediate color gamut coordinate is determined between the two or more target color gamuts according to the weight factor W based on the determined intermediate color gamut as depicted in FIG. 7.

That is, one or more target color gamut are set according to the user's setting or the initial setting mode, and the original color gamut coordinate is converted to a plurality of target color gamuts based on the plurality of target color gamut coordinates. Then, the intermediate color gamut coordinate is determined between the plurality of target color gamut coordinates located in two or more positions according to the set weight factor.

In FIGS. 6 and 7, the weight factorW, which is a factor for determining the intermediate color gamut coordinate, may be differently set according to characteristics of an image included in the image data Data1 input to the display device, color information or selection of a color setting mode set by the user.

Since there may be eight color extreme values in the RGB color space, a maximum of eight weight factors may be set according to the extreme values of each respective color.

Since the intermediate color gamut is changed according to the weight factors, it is possible to adjust a color gamut conversion intensity or selectively make a desired intermediate color gamut weight factor value.

The weight factor may be randomly set by selectively determining the color setting mode in a screen setting mode of the user, and may be automatically adjusted according to an external environment, information on an image characteristic, and/or a color characteristic for each pixel included in the input data gradually or stage by stage.

Referring back to FIG. 1, when the color gamut conversion function generator 30 generates the color gamut conversion function for determining the intermediate color gamut according to the exemplary embodiment of the present invention, the color gamut conversion function may be determined in terms of the weight factors.

At this time, the color gamut conversion function generator 30 determines the weight factor based on information transferred from the mode selector 20 or the image analyzer 10, and reflects the determined weight factor in generating the color gamut conversion function.

The mode selector 20 transfers color setting mode information of a screen setting randomly selected by the user, and the image analyzer 10 analyzes information on an image characteristic and a color characteristic for each pixel included in Data1 and transfers a result value.

Then, the color gamut conversion function generator 30 selectively or collectively uses the information of the mode selector 20 and the information of the image analyzer 10 to determine the weight factor(s), and can generate the color gamut conversion function according to the determined weight factor(s).

The color gamut conversion function generator 30 may receive information regarding the external environment, such as external illuminance, light intensity, and the like obtained by the external illuminance controller 40, to set the weight factor(s) for the environment, and can consider the set weight factor(s) in generating the color gamut conversion function.

The color setting mode included in the mode selector 20 may be classified into various types, and is not limited in particular. For example, the color setting mode may be classified into an off mode in which the color adjustment is not performed, an accurate mode in which color accuracy is emphasized to improve the definition of the image, a moderate mode in which a comfortable image may be provided according to a basic color adjustment, an aggressive mode in which a total high color gamut of the display device is used, an adaptive mode in which an optimum intermediate color gamut is automatically determined according to an image characteristic of the input image and the like. The user randomly selects a color setting mode of the screen, and the color gamut conversion function generator 30 assigns the weight factor(s) according to the selected color mode.

If the user selects the color gamut conversion mode such as the accurate mode, the moderate mode or the aggressive mode, the weight factor may be determined by simultaneously reflecting the corresponding selected mode and the image information transferred from the image analyzer 10 together.

Meanwhile, if the user selects the adaptive mode, the color gamut conversion function generator 30 can determine the weight factor(s) based on only the result value of the image information analyzed by the image analyzer 10.

Further, if the user selects the off mode, a function of each means of the color gamut conversion system is inactivated, and thus no color gamut conversion is performed.

An implementation type assigning the weight factor(s) by using a result value analyzed from Data1 by the image analyzer 10 and determining the color gamut conversion function will be described.

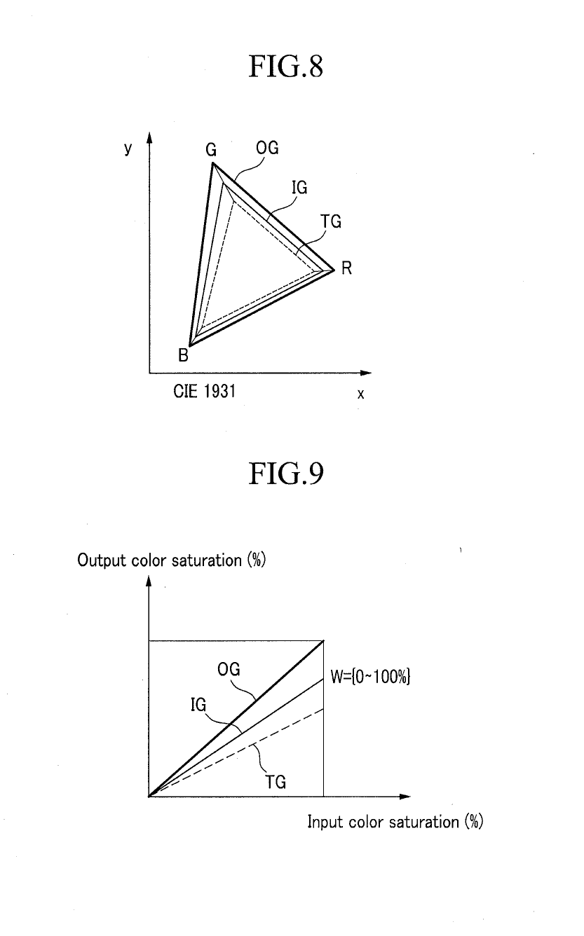

FIGS. 8 and 9 illustrate graphs showing a relation between a color saturation degree and a color gamut conversion weight factor.

Specifically, FIG. 8 briefly illustrates the intermediate color gamut IG according to the present invention connecting predetermined color coordinate values calculated between the original color gamut OG and the target color gamut TG in the CIE color coordinate system.

Further, the graph of FIG. 9 shows a circumstance where the weight factor(s) W are all determined to have the same value between 0 to 1.0 (0 to 100% in a case of a percentage), according to the image characteristic included in Data1 or the color saturation degree of the pixel. In this case, the intermediate color gamut IG is set according to the determined weight factor(s) regardless of the color saturation degree.

The image analyzer 10 can classify the color characteristics of Data1 through various methods, and apply a method such as the following equation for obtaining the color saturation degree in the simplest way.

Color saturation degree(%)=(MAX[R,G,B]−MIN[R,G,B])/MAX[R,G,B]

Here, MAX[R,G,B] denotes a maximum value of R, G, B three primary color values in one pixel, and MIN[R,G,B] denotes a minimum value of the R, G, B three primary color values in the one pixel.

The color gamut conversion function generator 30 can find a conversion function for determining the intermediate color gamut after receiving information on the color saturation degree of the input data calculated by the image analyzer 10, and can use the weight factor(s) according to the color saturation degree.

Where the color saturation degree is high, the color coordinate is located in an extreme side of the color gamut, and the weight factor(s) may be differentially and gradually adjusted by associating the color saturation degree with an intensity of the color gamut conversion.

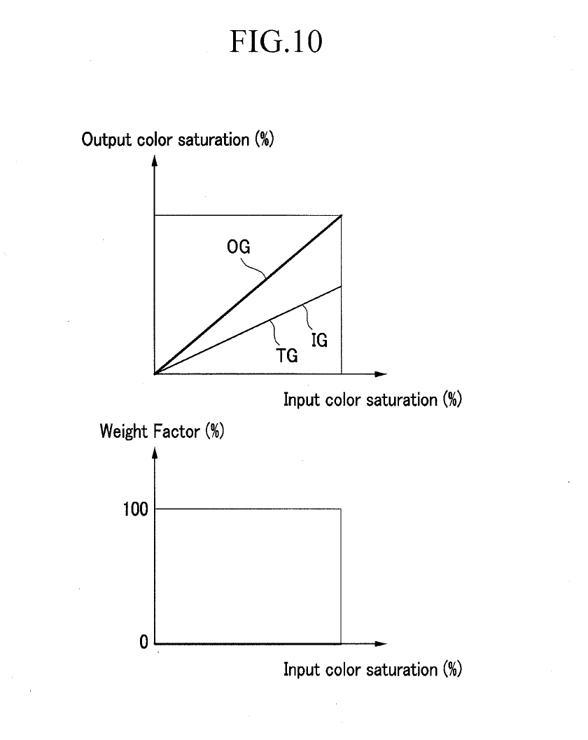

FIGS. 10 to 12 illustrate graphs showing an intermediate color gamut conversion curve generated when a simple weight factor is applied to a color gamut conversion method according to an exemplary embodiment of the present invention. That is, FIGS. 10 to 12 show a simple linear intermediate color gamut IG setting method using a correlation between a weight factor (%) and a color conversion intensity and the weight factor.

In the following description of the present invention, a color gamut conversion curve is a curve indicated on a graph according to the color gamut conversion function, and may be generally accepted as a similar concept to the color gamut conversion function, as a reference of the color coordinate conversion of the input data. Further, the indication on the graph below as the color gamut may refer to the color gamut conversion function (curve).

In FIGS. 10 to 12, a graph located in a lower part is a graph showing a relation between an input color saturation degree (%) and the weight factor (%), and a graph located in an upper part is a graph showing a shape of the color gamut in a correlation between the input color saturation degree (%) and an output color saturation degree (%) according to a corresponding weight factor.

FIG. 10 shows a case where the weight factor(s) are equally 0% regardless of the input color saturation degree (%), so the intermediate color gamut IG corresponds to the target color gamut TG because the weight factor is not applied. In this case, the input data is not converted to the inherent original color gamut of the display panel, but is converted to the standard color gamut (target color gamut) of the general video content, and then displayed.

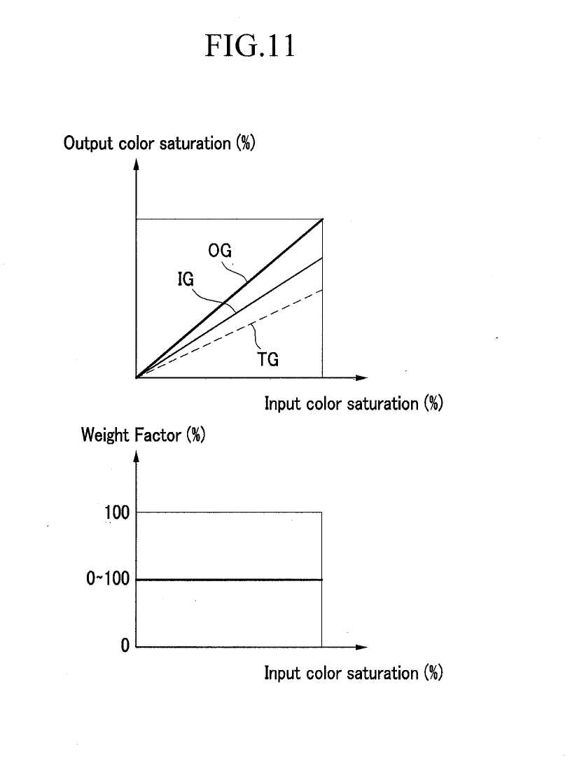

FIG. 11 shows a case where the weight factor(s) equally have a predetermined value between 0 to 100% regardless of the input color saturation degree (%), and the intermediate color gamut is determined by the predetermined weight factor(s). Accordingly, as shown in a correlation between the input color saturation degree (%) and the output color saturation degree (%) illustrated in an upper graph of FIG. 11, the intermediate color gamut IG is determined in a range between the original color gamut OG and the target color gamut TG.

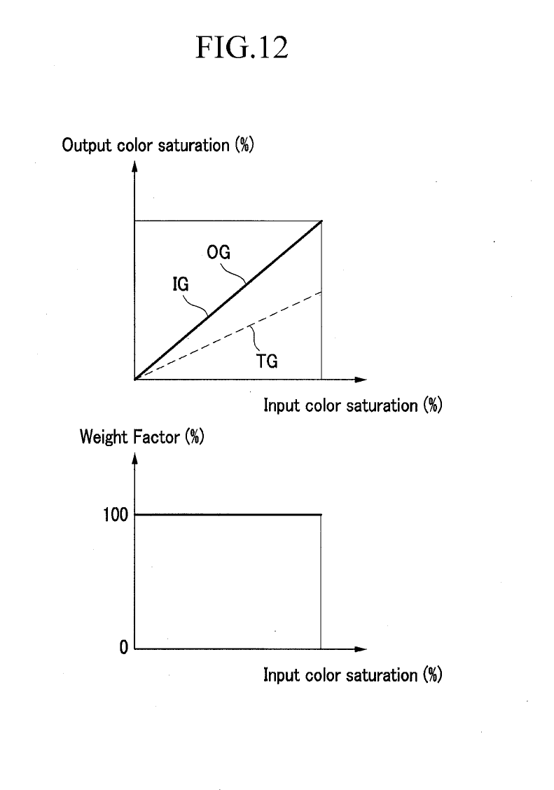

FIG. 12 shows a case where the weight factor(s) equally has a value of 100% regardless of the input color saturation degree (%), and the intermediate color gamut IG corresponds to the original color gamut OG because the weight factor of 100% is applied. In this case, the inherent original color gamut of the display panel is directly used when the input data is displayed.

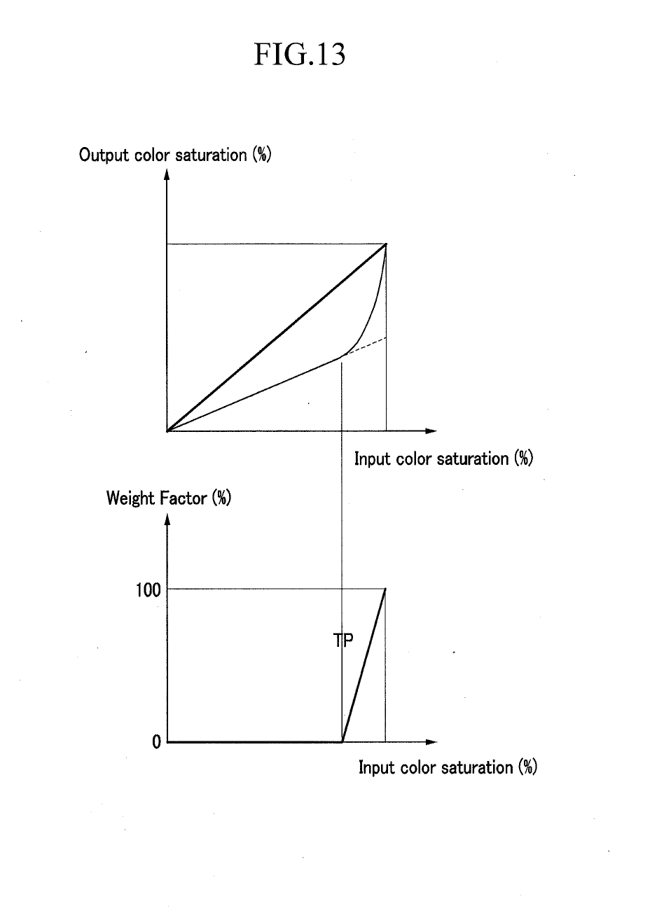

Meanwhile, FIGS. 13 to 16 illustrate graphs showing an intermediate color gamut conversion curve generated when the weight factor(s) may vary according to the input color saturation degree. The lower graphs of FIGS. 13 to 16 show a correlation between the input color saturation degree (%) and the weight factor(s) (%), and upper graphs of FIGS. 13 to 16 show a shape of the color gamut in the correlation between the input color saturation degree (%) and the output color saturation degree (%) based on a variable weight factor(s).

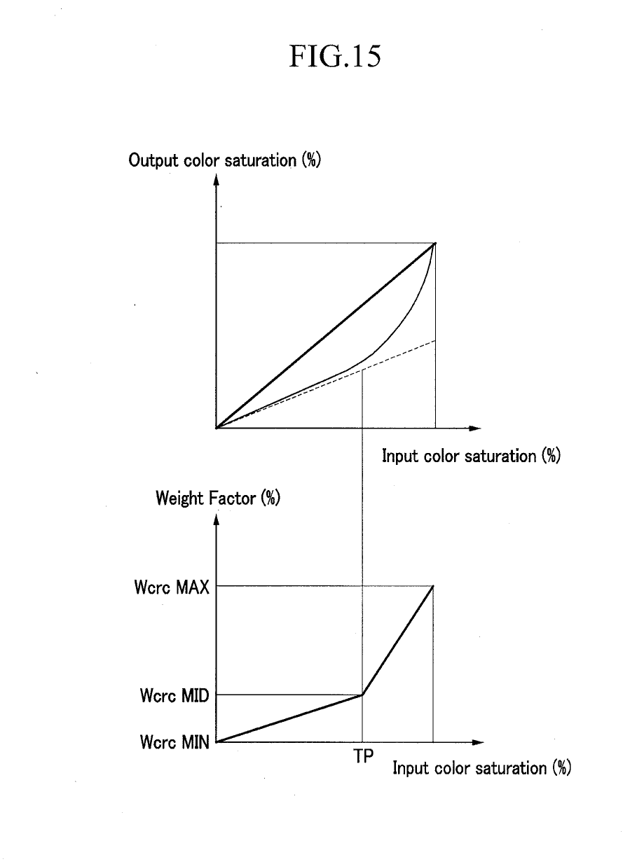

As illustrated in FIGS. 13 to 16, various intermediate color gamut IG conversion curves may be set by adjusting the weight factor(s) gradually or stage by stage adjusting according to the color saturation degree. The graphs of FIGS. 13 to 16 are only for illustration, and there are various intermediate color gamut conversion curves generated by applying various weight factors. That is, as shown in FIG. 15, a minimum value Wcrc MIN, an intermediate value Wcrc MID, a maximum value Wcrc MAX and an input color saturation turning point TP of the weight factor(s) are set as four parameters for setting the color gamut conversion curve, and most intermediate color gamut conversion curves can be made by adjusting values of the four parameters.

The minimum value Wcrc MIN may be 0%, the maximum value Wcrc MAX may be 100% and the intermediate value Wcrc MID may a predetermined value between the minimum value and the maximum value, and the input color saturation turning point TP may be a color saturation degree value of a point at which a the weight factor(s) change.

Further, the minimum, intermediate, and maximum values are not limited to those described above, and a setting factor of the color gamut conversion curve may be further changed by converting a part of an algorithm if a more detailed setting is required.

The setting factor (parameter) of color gamut conversion curve may be determined or added by the color gamut conversion function generator 30 in order to determine the weight factor(s). Further, the color gamut conversion function generator 30 can adjust a value of the setting factor, and accordingly, it is possible to set various intermediate color gamut conversion curves.

In FIG. 13, the weight factor(s) is set to be maintained in the minimum value Were MIN 0% in the low color area, and rapidly increase from the input color saturation turning point TP up to the maximum value Wcrc MAX 100%.

Accordingly; the intermediate color gamut IG is equal to the target color gamut until the input color saturation turning point TP, and increases in a form of the non-linear curve after the input color saturation turning point TP.

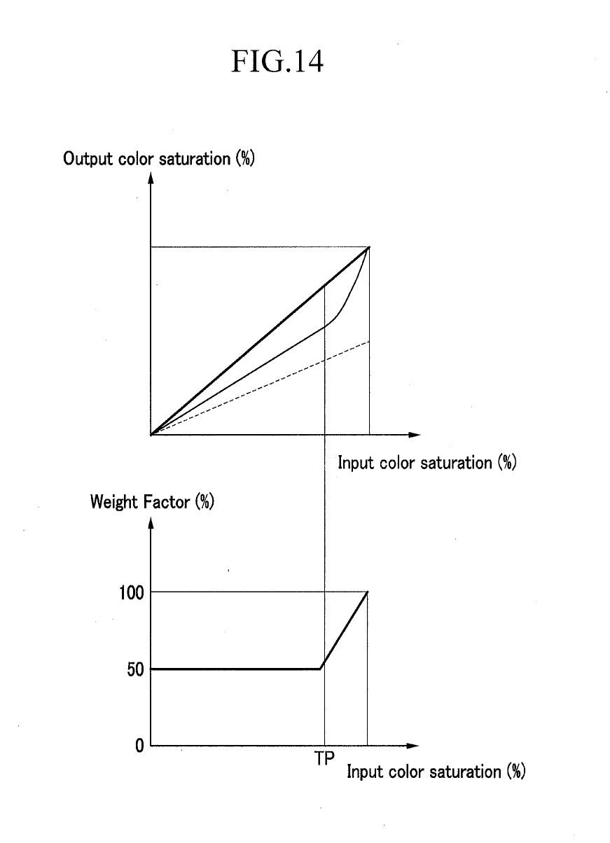

In FIG. 14, the weight factor is maintained in the minimum value Wcrc MIN corresponding to 50% during the low color area, and the weight factor starts to increase at the input color saturation turning point TP and increases up to the maximum value Wcrc MAX corresponding to 100%.

Accordingly, the intermediate color gamut of FIG. 14 is set as an intermediate area between the original color gamut OG and the target color gamut TG during the area until the input color saturation turning point TP, and increases in a form of the non-linear curve in the area after the input coor saturation turning point TP.

In FIG. 15, weight factor linearly increases between the minimum value Wcrc MIN and the intermediate value Wcrc MID and between the intermediate value Were MID and the maximum value Wcrc MAX, and the weight factor is set to have different slopes starting from the input color saturation turning point TP.

Accordingly, the intermediate color gamut IG of FIG. 15 increases between the original color gamut OG and the target color gamut TG in a form of the non-linear curve while having different slopes with the input color saturation turning point TP as a boundary.

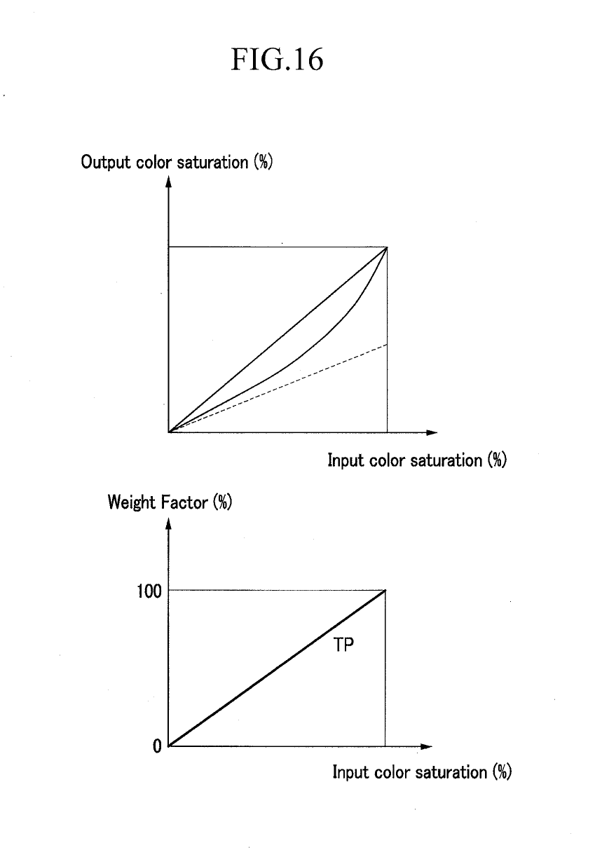

In FIG. 16, weight factor(s) is set as various values while linearly increasing according to the input saturation degree without the input color saturation turning point TP, and accordingly, the intermediate color gamut IG increases between the original color gamut OG and the target color gamut TG in a form of the non-linear curve.

As illustrated in FIGS. 13 to 16, intermediate color gamut conversion curves are maintained close to the target color gamut in the low color part, and change non-linearly in the high color part according to the high color area of the original color gamut.

Accordingly, when an image according to the input data is displayed by variously changing the weight factor to set the intermediate color gamut conversion curve, a low hue part can be expressed with an accurate color like the general video signal, and a high hue part can be expressed with inherent high color characteristics of the display device.

Some embodiments describe a method in which when a color distribution of an image is analyzed in Data1, the color gamut conversion function generator 30 automatically selects the color gamut conversion function to determine the intermediate color gamut conversion curve and Data1 is converted according to the intermediate color gamut conversion curve determined by the color gamut converter 50.

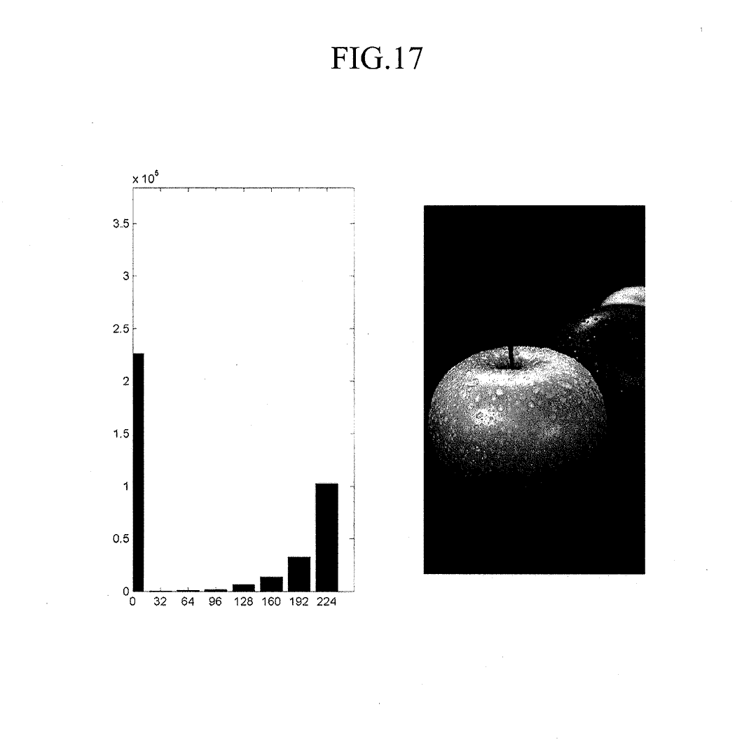

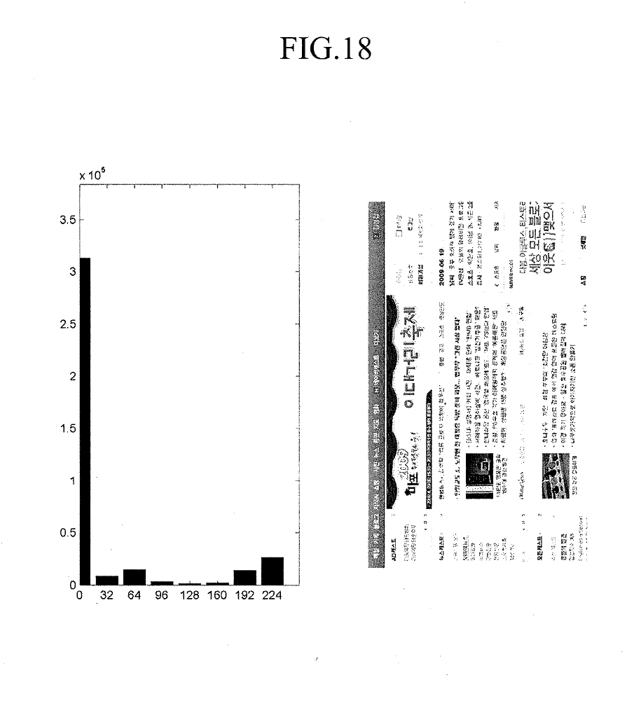

FIGS. 17 and 18 illustrate a color saturation degree distribution for each image of the input image, and illustrate histograms in which a color saturation degree for each pixel is accumulated for each display area.

The horizontal axis of the histograms of FIGS. 17 and 18 indicates the color saturation degree and a vertical axis indicates a number of pixels included in the display panel. The horizontal axis in the histogram of FIGS. 17 and 18 include eight stages classified according to an extent of the color saturation degree, but the horizontal axis of the present invention is not limited thereto and may be classified into a smaller number of stages, for example, three stages.

An example screen of FIG. 17 shows an arrangement of a green apple and a red apple on a black background. Referring to the histogram according to the example screen, the number of counts of the pixel indicates a large value in a section where the color saturation degree is 0 as a black background, and the numbers of counts of the pixel indicate equal values in saturated areas due to color distributions of green and red of the apples at the same time. That is, colors such as red, green and blue, yellow, cyan, magenta and the like have a high color saturation degree, and block or white has a low color saturation degree. Expressing the example screen of FIG. 17 by using the histogram, most pixels are counted in a point where the color saturation degree is 0 since black having a low color saturation degree occupies a wide area in the screen as a background color. Since areas of the apples represented by dark colors such as green and red occupy wide areas in the screen at the same time, the number of corresponding pixels is highly counted in the color saturation degree near the 255 saturation.

Meanwhile, an example screen of FIG. 18 is a web site, and most areas are full of black and white having the saturation degree of 0%, and some areas corresponding to saturated areas are full of green. Accordingly, most pixels of the display panel are counted at a point where the color saturation degree of the histogram is 0 due to a white background, and the number of pixels is counted in a low level in the remaining areas.

As described above, since the color saturation degree distribution varies depending on the image characteristic, image types can be classified through the histogram for each characteristic of Data1 by classifying the color saturation degree stages into a plurality of stages and contracting the color saturation degree stages.

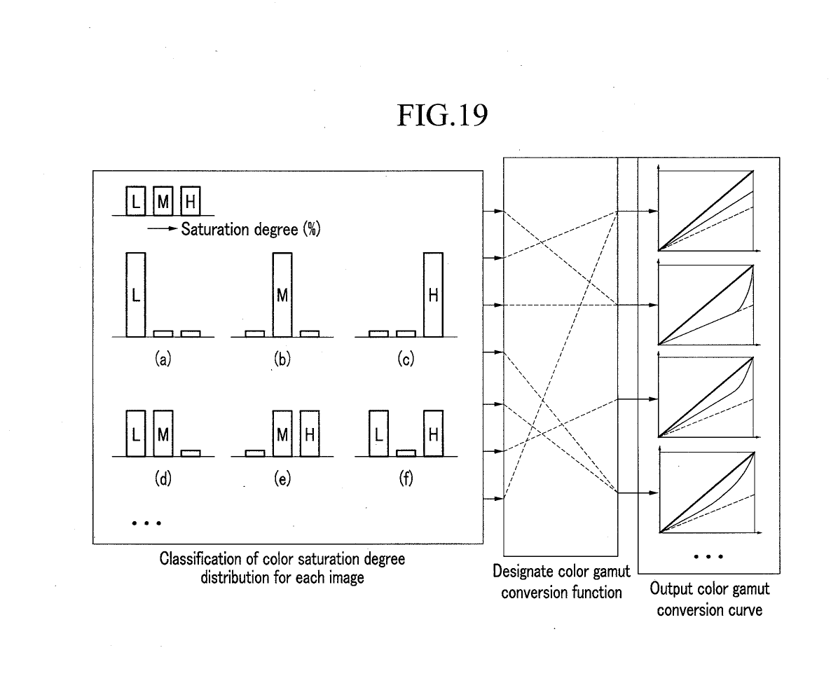

FIG. 19 schematically illustrates that image types are classified for each characteristic of the input data, and the color gamut conversion curve is selected according to the classification. In analysis of the histogram of the color saturation degree according to an exemplary embodiment of FIG. 19, color saturation degree areas are divided into three stages such as low/middle/high stages. In FIG. 19, image characteristics are classified into six types, but it is only an example and distribution shapes of the image characteristics can be classified into various numbers according to stage classification of the color saturation degree areas in the horizontal axis.

Referring to FIG. 1, the image analyzer 10 receives Data1, analyzes characteristics for each image, such as the color saturation degree, and classifies Data1 for each type illustrated in FIG. 19. Then, the color gamut conversion function generator 30 having obtained information on the color saturation distribution of classified Data1 can designate the color gamut conversion function corresponding to the color saturation degree distribution type of Data1. Accordingly, the intermediate color gamut conversion curve according to the color gamut conversion function is generated.

Referring to FIG. 19, the color saturation degree distributions of the input image are classified into a case where the color saturation degree is uniformly distributed to the three stages such as the low/middle/high stages, a case where the color saturation degree is concentrated in low hue, and a case where the color saturation degree is concentrated in high hue. The color gamut conversion function is designated to be the most suitable for an image classified through cognitive and emotional appraisal and experiment. The intermediate color gamut conversion curve is generated according to the selected conversion function; and then the color saturation degree of the input data is modulated and output for each pixel according to the intermediate color gamut via the color gamut conversion process.

Accordingly, when the input data is converted by matching the image color distribution characteristic and the color conversion function, and extracting the intermediate color gamut conversion curve, the low hue area part maintains the color accuracy and the high hue area part can take advantage of the high color expression of the display device. Accordingly, it is possible to both suppress an exaggerated color and express high color characteristics at the same time. Here, in order to enable a natural color change and a cognitively exaggerated color not to be visible, the color gamut conversion function matched for each type as shown in FIG. 19 should be determined through various evaluations.

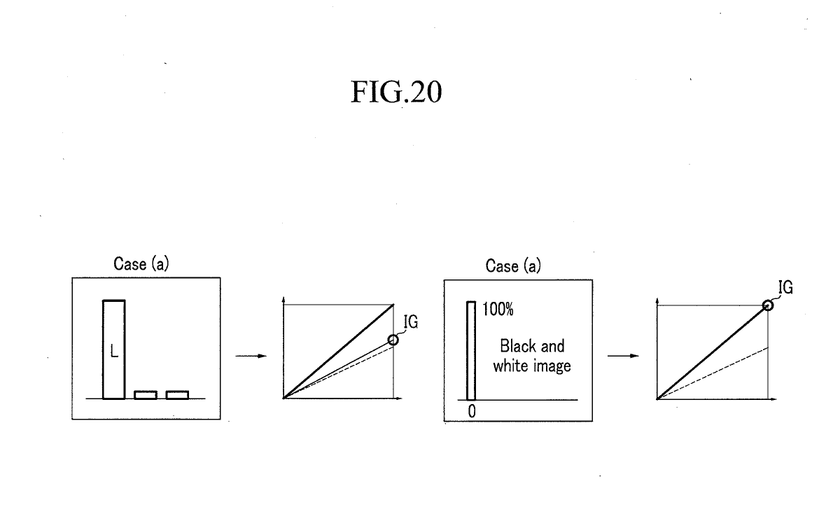

FIGS. 20 to 23 illustrate examples of determining the color gamut conversion function according to the color saturation degree distribution type for each image.

FIG. 20 illustrates a case where the color saturation degree distribution type of the image corresponds to an achromatic color or low chroma like a case (a) of FIG. 19. That is, when the image distribution of Data1 is concentrated in a low hue area L, the intermediate color gamut conversion function IG can be determined by slightly increasing a slope of the color gamut conversion function in comparison with a slope of the target color gamut

However, when the image is a black and white image (corresponding to a case of an achromatic color of 100%) extended from a case where the image distribution is concentrated in a low hue area, it is pointless determining the conversion function because an there is no effect of the color gamut conversion.

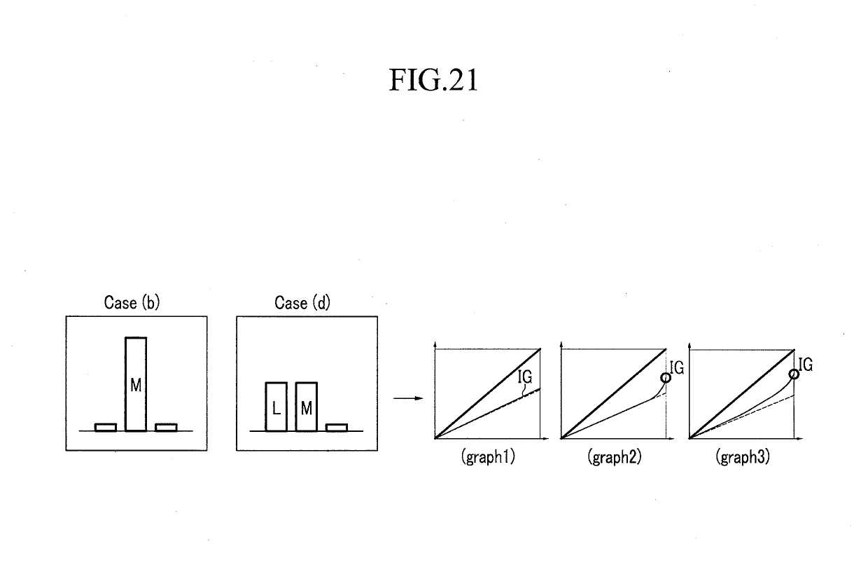

FIG. 21 illustrates a case where a color saturation degree type of the image has many moderately color-saturated areas M like a case (b) and a case (d) of FIG. 19.

Since the above cases correspond to a case of being cognitively sensitive to a change in a color, the color gamut conversion function having a minimum change in the standard color gamut (target color gamut) may be determined. The intermediate color gamut conversion function such as graph 1 may be mainly determined, but color expression in the high color area may be emphasized by restrictively up-adjusting a slope and a maximum value as shown by in graph2 and graph3, as opposed to no adjustment as shown by graph1.

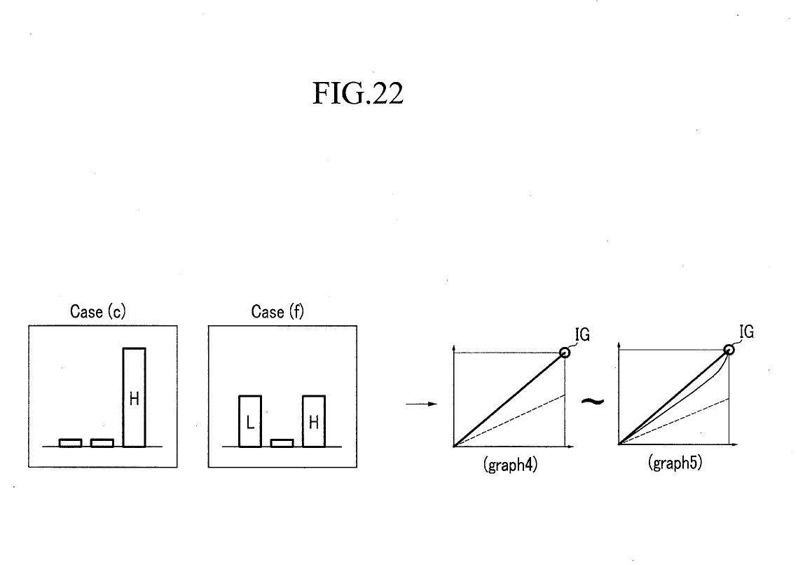

FIG. 22 illustrates cases equal to a case (c) and a case (f) of FIG. 19. The case (c) corresponds to a case where the color-saturated area of the image predominates, and the case (f) corresponds to a case where low chroma and high chroma equal to each other. When the image of Data1 is as shown in FIG. 22, colors in the image can be expressed by further emphasizing the high chroma. Accordingly, the original color gamut of the display device can be directly expressed as shown in graph4 of FIG. 22. In some embodiments, as shown in graph5, a slope slightly reduced for middle chroma is partially included in the determination of the intermediate color gamut conversion curve.

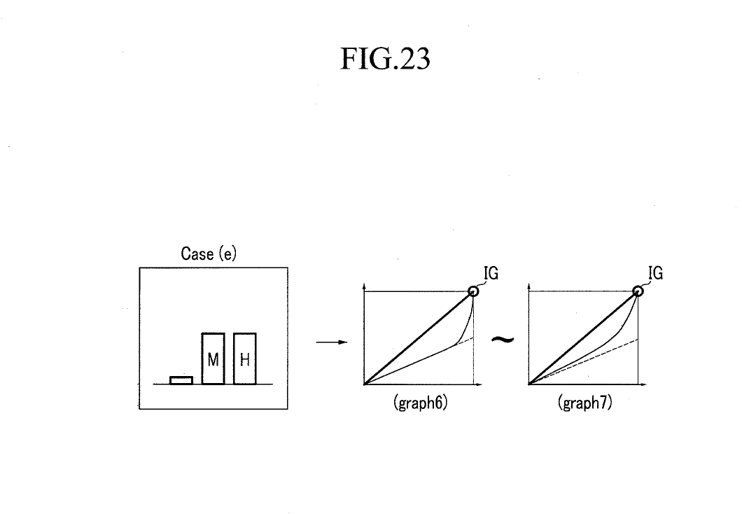

FIG. 23 illustrates a case where middle chroma M and high chroma H simultaneously predominate in a color saturation degree distribution type of the image as shown in a case (e) of FIG. 19.

Accordingly, the intermediate color gamut conversion curves can be determined as shown in graph6 and graph7 of FIG. 23. That is, in order to simultaneously satisfy the color gamut accuracy and the high chroma emphasis, the conversion curve of emphasizing the color may be determined by maintaining the color gamut most closely to the standard color gamut (target color gamut) during the middle area and gradually enlarging the color gamut in the highly saturated area. However, since a point where a rapid change takes place in the conversion curve may be expressed as a boundary in the screen, the point may be set to have a gentle slope. the slope of the conversion curve increases, as another exemplary embodiment.

The resulting value of the Data1 analyzed by the image analyzer 10 may be the weight factor(s) determined according to the image characteristics or the color characteristic for each pixel as described with reference to FIGS. 8 to 16, or may be the information classified for each histogram type of the color saturation degree distribution of the image as described with reference to FIGS. 17 to 23, but the result value is not necessarily limited to such exemplary embodiments.

Returning to the configuration of the color gamut conversion system 100 of FIG. 1, the configuration means of the color gamut conversion system will be described in associated with the color gamut conversion method in time series.

First, Data1 is supplied to the color gamut conversion system 100 from the external source, and the input data is transferred to the image analyzer 10 and the color gamut converter 50.

The image analyzer 10 analyzes the transferred Data1, and calculates a characteristic result value corresponding to the factor for determining the intermediate color gamut conversion curve according to the present invention and transfers the calculated value to the color gamut conversion function generator 30.

Meanwhile, the mode selector 20 can transfer information according to a setting mode selected by the user from the color setting modes for the screen display, and information on the weight factor(s) corresponding to the selected information of the color setting mode for the screen display preset for being used as the factor for determining the intermediate color gamut conversion curve to the color gamut conversion function generator 30. In some embodiments, the weight factor(s) corresponding to the selected information may be set as a predetermined value corresponding to the color setting mode, stored in the storage unit 70, and transferred to the color gamut conversion function generator 30.

The factor used for determining the conversion function by the color gamut conversion function generator 30 may be different according to the color setting mode.

The external illuminance controller 40 obtains information related to an external environment factor of the display device such as external illuminance, and can transfer the obtained information to the color gamut conversion function generator 30. The information related to the environment factor of the display device may be transferred to the data scaler and power controller 60 in order to control the amount of power consumed.

When illuminance is high, such as in an outdoor setting, duthe visibility of the display device can be improved by maintaining the color gamut in a high state when the color gamut conversion function generator 30 sets the intermediate color gamut conversion function. Further, the color gamut may be adjusted in a direction of increasing the color accuracy and the image quality in an indoor setting, by reducing the color gamut again when the color gamut conversion function generator 30 sets the intermediate color gamut conversion function.

For this purpose, the color gamut conversion function generator 30 can adjust a range of the color gamut conversion weight factor for each illuminance section or change a shape of the color gamut conversion curve. The external illuminance controller 40 may transfer the preset weight factor(s) according to the external environment information to the color gamut conversion function generator 30 according to the implementation type.

The color gamut conversion function generator 30 can use all or at least one of result values received from the image analyzer 10, the mode selector 20 and the external illuminance controller 40 to determine the intermediate color gamut conversion function.

When the color gamut conversion function generator 30 determines the intermediate color gamut conversion function between the original color gamut and the target color gamut, the color gamut conversion function generator 30 transfers the intermediate color gamut to the color gamut converter 50, and the color gamut converter 50 converts the color coordinate of Data1 according to the intermediate color gamut conversion function.

Image data including the color coordinate converted according to the intermediate color gamut conversion function is transferred to the data scaler and power controller 60.

The data scaler and power controller 60 finally scale a color gamut converted data value. That is, the data scaler and the power controller 60 rescale a data change generated after the color gamut conversion so that power consumption is not increased in a display such as an OLED display. Then, output data Data2 including the resealed data value is generated and transferred. Accordingly, the data scaler and power controller 60 have the function of controlling the supply of power consumed in the display device through controlling the final data value.

Further, since the data value resealed by the data scaler and power controller 60 corresponds to final luminance of the image displayed in the display panel, the data scaler and power controller 60 can scale a data scale value according to external illuminance in association with the external illuminance controller 40, and increase the visibility if necessary although the power consumption is somewhat increased.

Some embodiments of a color gamut conversion system do not include the frame buffer and operates without the frame buffer.

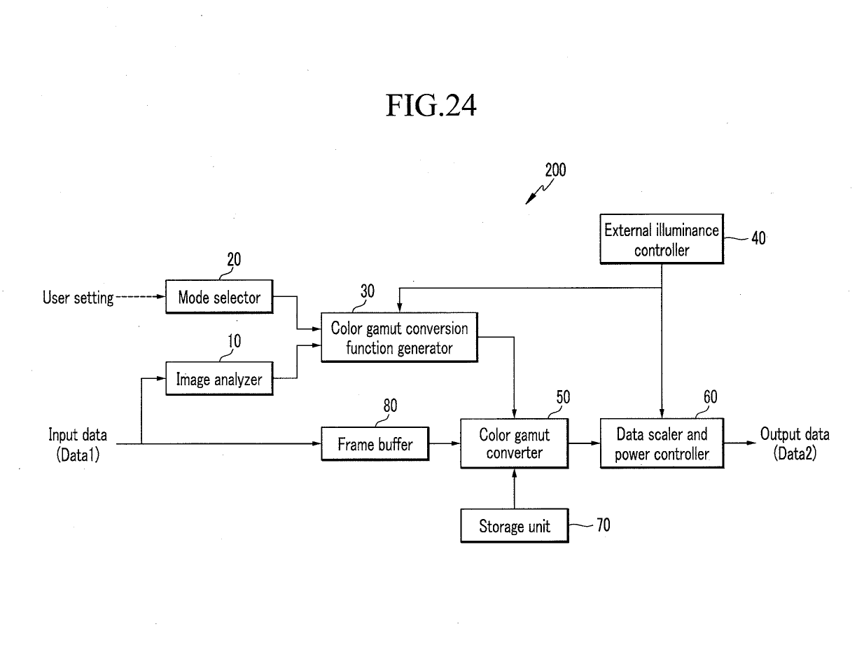

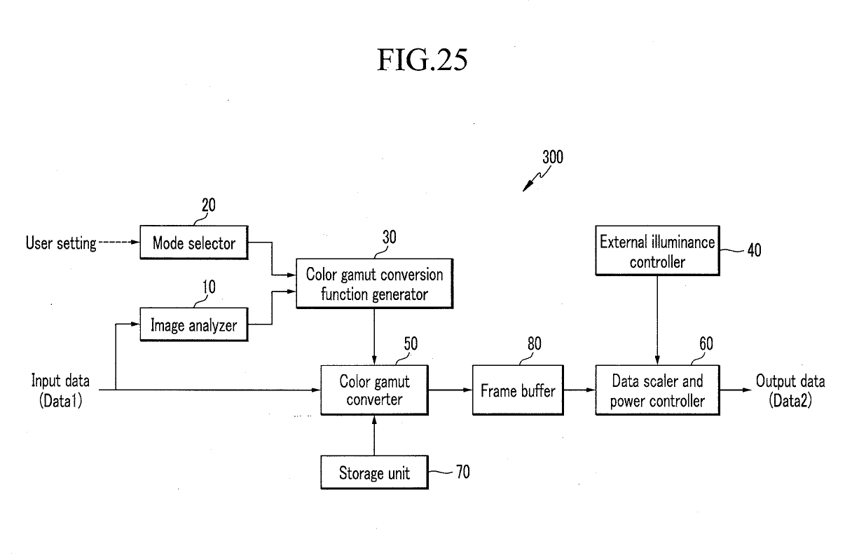

In some embodiments, color gamut conversion systems include a frame buffer. FIGS. 24 and 25 illustrate configurations of color gamut conversion systems which include the frame buffer. Some of the functions and features of the embodiment depicted in FIGS. 24 and 25 have been described elsewhere herein, and thus are not repeated here.

FIG. 24 illustrates a color gamut conversion system 200 having the frame buffer therein, and the frame buffer 80 is provided at a front end of the color gamut converter 50. Accordingly, Data1 is first transferred to the image analyzer 10 before being stored in the frame buffer 80. Accordingly, the color gamut conversion function is selected through analysis of the image characteristics included in the input data, and the selected conversion function is applied to data which is stored in the frame buffer 80 and then output.

Since a processing related to external illuminance in the color gamut conversion system 200 according to the exemplary embodiment of FIG. 24 should be adjusted according to an illuminance change separately from a result of the image analysis, the external illuminance controller 40 may be physically located in a back end of the frame buffer 80.

The frame buffer 80 is provided at a back end of the color gamut converter 50 in a color gamut conversion system 300 according to the exemplary embodiment of FIG. 25.

The color gamut conversion for each illuminance may be omitted according to an implementation type. In this case, most color gamut conversion functions may be located in a front end of the frame buffer 80. Further, configuration means for performing a necessary function such as the data scaler and power controller 60 is disposed in a back end of the frame buffer 80. Then, the data scaler and power controller 60 operate only when the data is recorded in the frame buffer 80, so that power consumption may be significantly reduced.

Although it is illustrated that the storage unit 70 is connected to the color gamut converter 50 in the color gamut conversion systems of FIGS. 1, 24 and 25, the storage unit of the present invention is not limited thereto, and can be connected to each configuration means of the total system to store various result values and information obtained by the total system.

Further, the storage unit 70 can store an offset value or setting values which which may be set and supplied according to the function of each configuration means of the system. For example, the storage unit 70 can store a weight factor setting value for each mode predefined according to the screen setting mode in a form of a lookup table in association with the mode selector 20. In addition, the storage unit 70 can store inherent original color gamut information of the display panel or at least one standard color gamut (target color gamut) information required for calculating the intermediate color gamut in a form of the lookup table in association with the color gamut converter 50.

Furthermore, the storage unit 70 can store input information or setting information related to the operation of the color gamut conversion system.

The referenced drawings and the detailed description of the present invention are only for illustration, and used for illustrative purposes so not used to restrict the meaning or limit the scope of the present invention described in the claims. Accordingly, the materials of each component described in the specification can easily be selected and substituted from various materials known to those skilled in the art. Further, those skilled in the art can omit a part of the components described herein without degrading the performance or can add components to improve the performance. In addition, those skilled in the art can change a sequence of the process steps described herein according to the process environment or the process apparatus. Therefore, the scope of the present invention must be defined by the claims and their equivalents rather than the foregoing embodiments.

<Description of symbols>

| | |
|---|---|
| 100, 200, 300: Color gamut conversion system | |
| 10: Image analyzer | 20: Mode selector |
| 30: Color gamut conversion function generator | |
| 40: External illuminance controller | |
| 50: Color gamut converter | |
| 60: Data scaler and power controller | |
| 70: Storage unit | 80: Frame buffer |

What is claimed is:

1. A system for converting a color gamut, comprising:
a display device having a display panel;
a color gamut conversion function generator configured to generate a color gamut conversion function for determining an intermediate color gamut, wherein the intermediate color gamut is located in a color space between a predetermined color gamut corresponding to the display panel and a standard color gamut;
a color gamut converter configured to receive input data supplied from an external image source and convert a color coordinate of the input data according to the generated color gamut conversion function; and
a scaler configured to scale a value of the converted input data by the color gamut converter to generate output data, and to transfer the output data.

2. The system for converting a color gamut of claim 1, further comprising:
a frame buffer configured to be connected to a front end or a back end of the color gamut converter,
wherein if the frame buffer connected to the front end of the color gamut converter the frame buffer stores the input data, and if the frame buffer is connected to the back end of the color gamut converter, the frame buffer stores input data converted according to the generated color gamut conversion function.

3. The system for converting a color gamut of claim 2, further comprising an external illuminance controller connected to the back end of the frame buffer, the external illuminance controller configured to obtain external illuminance information of the display device and transfer the illuminance information to the scaler in order to control the supply of power to the display device.

4. The system for converting a color gamut of claim 1, further comprising an image analyzer configured to receive the input data, to generate a result value analyzed from characteristic information included in the input data, and to transfer the result value to the color gamut conversion function generator as one factor for use in generating the color gamut conversion function.

5. The system for converting a color gamut of claim 4, wherein the result value is at least one of: an image characteristic of the input data, a color saturation degree characteristic for each pixel, and classification information for each type of a color saturation degree distribution for each image.

6. The system for converting a color gamut of claim 4, wherein the result value is an image characteristic of the input data or a color saturation degree characteristic for each pixel, and wherein the color gamut conversion function generator is configured to determine the color gamut conversion function for determining the intermediate color gamut between the predetermined color gamut and the standard color gamut, by using a weight factor which is based on the result value.

7. The system for converting a color gamut of claim 6, wherein:
the weight factor has a predetermined value according to the color saturation and a variable value according to a predetermined high color area.

8. The system for converting a color gamut of claim 7, wherein:
when the weight factor has a variable value, s, the color gamut conversion function for calculating the intermediate color gamut changes non-linearly closely to the predetermined original color gamut in the predetermined high color area.

9. The system for converting a color gamut of claim 7, wherein:
the weight factor having a variable value is determined by parameters including a minimum value, a maximum value, a middle value between the minimum value and the maximum value, and an input color saturation turning point corresponding to a color saturation degree at a point where a tendency of the weight factor is changed.

10. The system for converting a color gamut of claim 4, wherein:
the result value is information generated by analyzing the input data and classifying a color saturation degree distribution for each image, for each type according to color saturation degree areas of at least three stages, and
the color gamut conversion function generator matches the color gamut conversion function for calculating the intermediate color gamut based on the result value for each type to determine the color gamut conversion function.

11. The system for converting a color gamut of claim 1, further comprising:
a mode selector configured to include at least one user-selectable color setting mode for controlling a screen color of the display panel and to transfer the user-selected color setting mode information to the color gamut conversion function generator.

12. The system for converting a color gamut of claim 11, wherein the mode selector is configured to select a color setting mode from one of: an off mode in which a color control is not performed, an accurate mode in which color accuracy and image definition are improved, a moderate mode in which a set color control is performed, an aggressive mode in which a high color gamut of the display panel is used, and an adaptive mode in which a color control is automatically performed according to an image characteristic of an input image.

13. The system for converting a color gamut of claim 11, wherein the mode selector is configured to select the color setting mode by selecting a weight factor corresponding to the color setting mode information from among one or more weight factors preset corresponding to one or more color setting modes, and to transfer the color gamut conversion function generator.

14. The system for converting a color gamut of claim 1, further comprising an external illuminance controller configured to obtain external environment information of the display device, and to transfer the external environment information to the color gamut conversion function generator as one factor for generating the color gamut conversion function for determining the intermediate color gamut.

15. A method of converting a color gamut, comprising:
receiving one or more factors for determining an intermediate color gamut located in a color space between a predetermined color gamut corresponding to a display panel of a display device and a standard color gamut;
generating a color gamut conversion function;
receiving input data from an external image source and converting a color coordinate of the input data according to the generated color gamut conversion function; and
scaling a value of the converted data and output the value as output data.

16. The method of converting a color gamut of claim 15, further comprising:
storing the input data in a frame buffer before or after converting of the color coordinate of the input data according to the generated color gamut conversion function.

17. The method of converting a color gamut of claim 15, further comprising obtaining external illuminance information of the display device and transferring the illuminance information to control power consumption of the display device.

18. The method of converting a color gamut of claim 15, further comprising:
obtaining one or more factors before generating the color gamut conversion function, wherein the one or more factors are at selected from at least one of: a first weight factor according to image characteristic information of the input data or color saturation degree characteristic information for each pixel, one or more second weight factors preset according to one or more color setting modes for controlling a screen color of the display panel, external environment information of the display device, and classification information for each type of color saturation degree distribution for each image analyzed from the input data.

19. The method of converting a color gamut of claim 18, wherein:
the first weight factor has a predetermined value according to the color saturation degree a variable value in a predetermined high color area.

20. The method of converting a color gamut of claim 19, wherein:
when the first weight factor changes non-linearly closely to a predetermined original color gamut in the predetermined high color area.

21. The method of converting a color gamut of claim 18, wherein:
when the one or more factors is the classification information for each type of the color saturation degree distribution, generating the color gamut conversion function by matching the color gamut conversion function based on the classification information for each type of color saturation degree distribution.

22. The method of converting a color gamut of claim 18, wherein the color setting modes include an off mode in which a color control is not performed, an accurate mode in which color accuracy and image definition are improved, a moderate mode in which a basically set color control is performed, an aggressive mode in which a high color gamut of the display panel is used, and an adaptive mode in which a color control is automatically performed according to an image characteristic of an input image, and
wherein the one or more second weight factors corresponding to one or more user-selected color setting modes.
